(19) United States
(12) Patent Application Publication
(10) Pub. No.: US 2017/0054496 A1
(43) Pub. Date: Feb. 23, 2017

(54) SUPPORTING REMOTE UNIT UPLINK TESTS IN A DISTRIBUTED ANTENNA SYSTEM (DAS)

(71) Applicant: Corning Optical Communications Wireless Ltd, Airport City (IL)

(72) Inventor: Ami Hazani, Ra'anana (IL)

(21) Appl. No.: 14/887,868

(22) Filed: Oct. 20, 2015

Related U.S. Application Data
(60) Provisional application No. 62/205,897, filed on Aug. 17, 2015.

(51) Int. Cl. H04B 10/077; H04Q 11/00; H04B 10/2575; H04W 24/06

(52) U.S. Cl. CPC H04B 10/0775; H04W 24/06; H04Q 11/0071; H04B 10/25751; H04Q 2011/0083

(57) ABSTRACT

Methods and systems for supporting remote unit uplink tests in a distributed antenna system (DAS) are disclosed. In this regard, in one aspect, a centralized test signal generator is provided in the DAS to generate uplink test signals for one or more remote antenna units (RAUs) under test (RUTs). By providing the uplink test signals to the one or more RUTs from the centralized test signal generator, it is possible to perform uplink tests more efficiently with reduced equipment cost. The uplink test signals are distributed to the one or more RUTs over a downlink communications medium of the DAS. In another aspect, the one or more RUTs return the uplink test signals to a signal monitor over an uplink communications medium of the DAS, whereby uplink performance of the one or more RUTs can be examined to help optimize the DAS to improve quality of service (QoS).

### PRIORITY APPLICATION

This application claims the benefit of priority under 35 U.S.C. §119 of U.S. Provisional Application No. 62/205897 filed on Aug. 17, 2015, the content of which is relied upon and incorporated herein by reference in its entirety.

### BACKGROUND

The disclosure relates generally to supporting remote unit uplink tests in a distributed antenna system (DAS) and, more particularly, to supporting remote unit uplink tests using a centralized test signal generator.

Wireless customers are increasingly demanding digital data services, such as streaming video signals. At the same time, some wireless customers use their wireless communication devices in areas that are poorly serviced by conventional cellular networks, such as inside certain buildings or areas where there is little cellular coverage. One response to the intersection of these two concerns has been the use of DASs. DASs include remote antenna units (RAUs) configured to receive and transmit communications signals to client devices within the antenna range of the RAUs. DASs can be particularly useful when deployed inside buildings or other indoor environments where the wireless communication devices may not otherwise be able to effectively receive radio frequency (RF) signals from a source.

In this regard, FIG. 1 illustrates distribution of communications services to remote coverage areas 10(1)-10(N) of a DAS 12, wherein ‘N’ is the number of remote coverage areas. These communications services can include cellular services, wireless services, such as RF identification (RFID) tracking, Wireless Fidelity (Wi-Fi), local area network (LAN), and wireless LAN (WLAN), wireless solutions (Bluetooth, Wi-Fi Global Positioning System (GPS) signal-based, and others) for location-based services, and combinations thereof, as examples. The remote coverage areas 10(1)-10(N) may be remotely located. In this regard, the remote coverage areas 10(1)-10(N) are created by and centered on RAUs 14(1)-14(N) connected to a head-end equipment (HEE) 16 (e.g., a head-end controller, a head-end unit, or a central unit). The HEE 16 may be communicatively coupled to a signal source 18, for example, a base transceiver station (BTS) or a baseband unit (BBU). In this regard, the HEE 16 receives downlink communications signals 20D from the signal source 18 to be distributed to the RAUs 14(1)-14(N). The RAUs 14(1)-14(N) are configured to receive the downlink communications signals 20D from the HEE 16 over a communications medium 22 to be distributed to the respective remote coverage areas 10(1)-10(N) of the RAUs 14(1)-14(N). In a non-limiting example, the communications medium 22 may be a wired communications medium, a wireless communications medium, or an optical fiber-based communications medium. Each of the RAUs 14(1)-14(N) may include an RF transmitter/receiver (not shown) and a respective antenna 24(1)-24(N) operably connected to the RF transmitter/receiver to wirelessly distribute the communications services to client devices 26 within the respective remote coverage areas 10(1)-10(N). The RAUs 14(1)-14(N) are also configured to receive uplink communications signals 20U from the client devices 26 in the respective remote coverage areas 10(1)-10(N) to be distributed to the signal source 18. The size of each of the remote coverage areas 10(1)-10(N) is determined by amount of RF power transmitted by the respective RAUs 14(1)-14(N), receiver sensitivity, antenna gain, and RF environment, as well as by RF transmitter/receiver sensitivity of the client devices 26. The client devices 26 usually have a fixed maximum RF receiver sensitivity, so that the above-mentioned properties of the RAUs 14(1)-14(N) mainly determine the size of the respective remote coverage areas 10(1)-10(N).

With reference to FIG. 1, uplink performance of the RAUs 14(1)-14(N) is a critical measurement for determining quality of service (QoS) of the DAS 12. Hence, uplink tests are needed in the DAS 12 to ensure that the RAUs 14(1)-14(N) are meeting QoS requirements of the DAS 12. In some cases, it may be possible to conduct the uplink tests on the RAUs 14(1)44(N) to determine their uplink performance by examining the uplink communications signals 201J that the RAUs 14(1)44(N) receive from the client devices 26. More commonly, the uplink tests are performed on the RAUs 14(1)44(N) based on uplink test signals as opposed to the normal uplink communications signals 20D, because it is easier to configure and control the uplink test signals to test different aspects of the uplink performance of the RAUs 14(1)-14(N).

No admission is made that any reference cited herein constitutes prior art. Applicant reserves the right to challenge the accuracy and pertinency of any cited documents.

### SUMMARY

Embodiments of the disclosure relate to supporting remote unit uplink tests in a distributed antenna system (DAS). In one example, in exemplary DASs disclosed, uplink tests can be performed on remote antenna units (RAUs) to determine uplink performance by distributing uplink test signals to one or more RAUs under test (RUTs). The uplink test signals can be configured and controlled to test various aspects of RAU uplink performance. In this regard, in one aspect, a centralized test signal generator is provided in the DAS. The centralized test signal generator is remotely located from the RAUs in the DAS. The centralized test signal generator is configured to generate uplink test signals for the one or more RUTs in the DAS. The centralized test signal generator may be provided in a head-end equipment (HEE) of the DAS as an example. By providing the uplink test signals to the one or more RUTs from the centralized test signal generator, as opposed to providing the uplink test signals from one or more respective test signal generators collocated with the one or more RUTs, it is possible to perform the uplink tests more efficiently with reduced equipment cost. The uplink test signals are distributed to the one or more RUTs over a downlink communications media of the DAS. In another aspect, the one or more RUTs return the uplink test signals to a signal monitor over an uplink communications media of the DAS, whereby uplink performance of the RUTs can be examined to help optimize the DAS to improve quality of service (QoS).

An additional embodiment of the disclosure relates to a DAS configured to support remote unit uplink tests. The DAS comprises an HEE communicatively coupled to a plurality of RAUs over at least one downlink communications medium and at least one uplink communications medium. The HEE comprises a signal monitor. The DAS also comprises a centralized test signal generator located remotely from the plurality of RAUs. The centralized test signal generator is configured to generate at least one uplink test signal and distribute the at least one uplink test signal to at least one RUT among the plurality of RAUs over the at least one downlink communications medium. The at least one RUT is configured to return the at least one uplink test signal to the HEE over the at least one uplink communications medium. The signal monitor is configured to analyze the at least one uplink test signal received from the at least one RUT to determine uplink performance of the at least one RUT.

An additional embodiment of the disclosure relates to a method for performing remote unit uplink tests in a DAS. The method comprises providing at least one uplink test signal from a centralized test signal generator to at least one RUT among a plurality of RAUs in a DAS. The centralized test signal generator is located remotely from the plurality of RAUs. The method also comprises returning the at least one uplink test signal from the at least one RUT to an HEE in the DAS. The method also comprises analyzing the at least one uplink test signal received from the at least one RUT to determine uplink performance of the at least one RUT.

An additional embodiment of the disclosure relates to an HEE in a DAS configured to support remote unit uplink tests. The HEE comprises a downlink service router communicatively coupled to a plurality of RAUs over at least one downlink communications medium. The downlink service router is configured to generate a plurality of downlink communication signals based on one or more downlink signals received from one or more signal sources. The downlink service router is also configured to provide the plurality of downlink communication signals to the plurality of RAUs, respectively, over the at least one downlink communications medium. The HEE also comprises an uplink service router communicatively coupled to the plurality of RAUs over at least one uplink communications medium. The uplink service router is configured to generate one or more uplink signals based on a plurality of uplink communication signals received from the plurality of RAUs, respectively, over the at least one uplink communications medium. The uplink service router is also configured to provide the one or more uplink signals to the one or more signal sources. The HEE also comprises a test signal generator. The test signal generator is configured to generate at least one uplink test signal to at least one RUT among the plurality of RAUs. The test signal generator is also configured to provide the at least one uplink test signal to at least one RUT through the downlink service router. The HEE also comprises a signal monitor configured to analyze the at least one uplink test signal returned by the at least one RUT and received through the uplink service router.

Additional features and advantages will be set forth in the detailed description which follows and, in part, will be readily apparent to those skilled in the art from the description or recognized by practicing the embodiments as described in the written description and claims hereof, as well as the appended drawings.

It is to be understood that both the foregoing general description and the following detailed description are merely exemplary and are intended to provide an overview or framework to understand the nature and character of the claims.

The accompanying drawings are included to provide a further understanding of the disclosure, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a schematic diagram of an exemplary distributed antenna system (DAS);

FIG. 2 is a schematic diagram of an exemplary DAS that supports conventional remote unit unit uplink tests by using respective test signal generators to generate respective uplink test signals for remote antenna units (RAUs) under test (RUTs);

FIG. 3 is a schematic diagram of an exemplary DAS that employs a centralized test signal generator to generate a plurality of uplink test signals for conducting remote unit uplink tests at a plurality of RAUs;

FIG. 4 is a flowchart of an exemplary uplink test process for supporting the remote unit uplink tests in the DAS of FIG. 3 using the centralized test signal generator;

FIG. 5 is a schematic diagram of another exemplary DAS, wherein an uplink test signal is modulated to an intermediate frequency (IF) before being distributed to an RUT among the plurality of RAUs;

FIG. 6 is a schematic diagram of another exemplary DAS, wherein an uplink test signal is shown being distributed from a centralized test signal generator provided in head-end equipment (HEE) to an RUT among a plurality of RAUs over at least one downlink test signal optical fiber comprised in an optical fiber-based downlink communications medium;

FIG. 7 is a schematic diagram of an RUT in the DAS of FIGS. 5 and 6, wherein an uplink test signal is wirelessly distributed to an uplink circuit in the RUT before being communicated to the HEE;

FIG. 8 is a schematic diagram of an exemplary RUT in the DAS in FIGS. 5 and 6, wherein an uplink test signal is directly provided to the uplink circuit in the RUT before being communicated to the HEE; and

FIG. 9 is a partial schematic cut-away diagram of an exemplary building infrastructure in which DASs employing a centralized test signal generator to generate a plurality of uplink test signals for conducting RAU uplink tests at a plurality of RAUs can be provided.

### DETAILED DESCRIPTION

Embodiments of the disclosure relate to supporting remote unit uplink tests in a distributed antenna system (DAS). In one example, in exemplary DASs disclosed, uplink tests can be performed on remote antenna units (RAUs) to determine uplink performance by distributing uplink test signals to one or more RAUs under test (RUTs). The uplink test signals can be configured and controlled to test various aspects of RAU uplink performance. In this regard, in one aspect, a centralized test signal generator is provided in the DAS. The centralized test signal generator is remotely located from the RAUs in the DAS. The centralized test signal generator is configured to generate uplink test signals for the one or more RUTs in the DAS. The centralized test signal generator may be provided in a head-end equipment (HEE) of the DAS as an example. By providing the uplink test signals to the one or more RUTs from the centralized test signal generator, as opposed to providing the uplink test signals from one or more respective test signal generators collocated with the one or more RUTs, it is possible to perform the uplink tests more efficiently with reduced equipment cost. The uplink test signals are distributed to the one or more RUTs over a downlink communications media of the DAS. In another aspect, the one or more RUTs return the uplink test signals to a signal monitor over an uplink communications media of the DAS, whereby uplink performance of the RUTs can be examined to help optimize the DAS to improve quality of service (QoS).

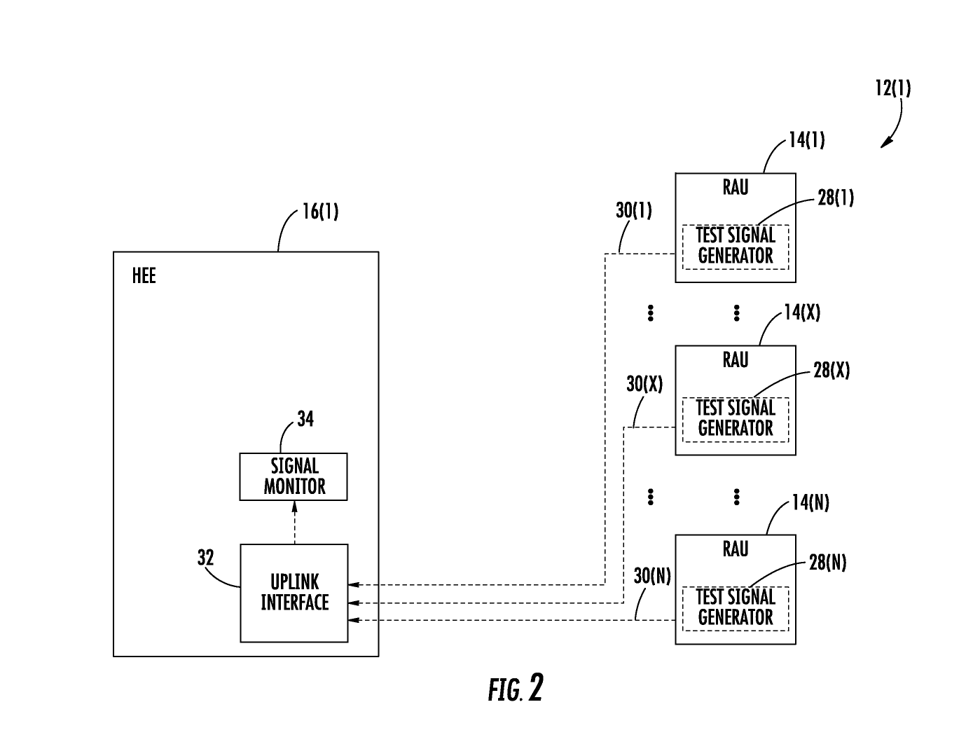

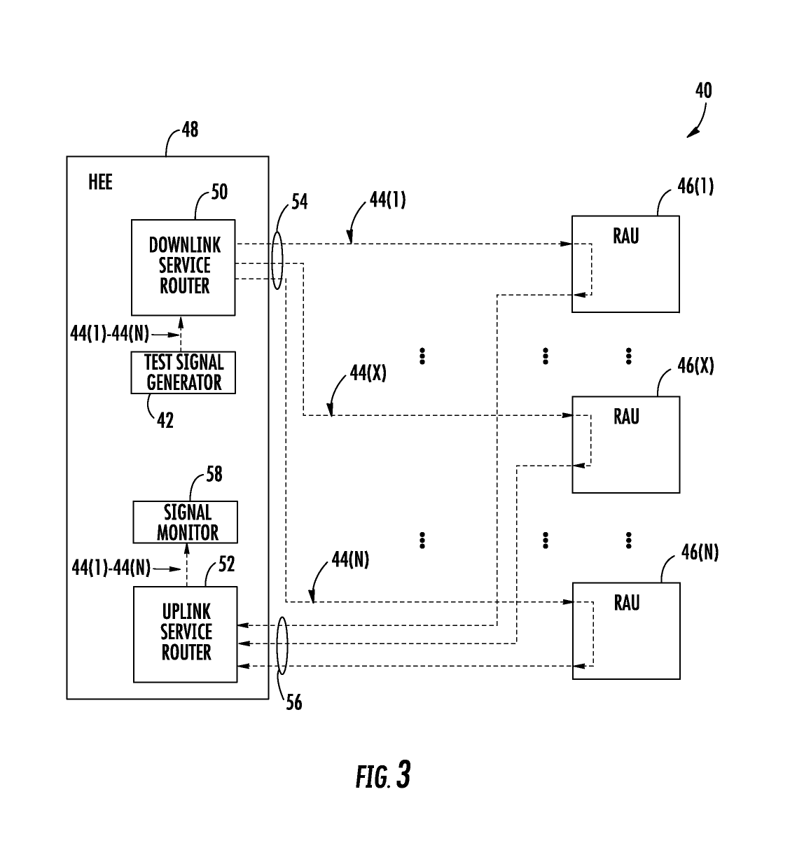

Before discussing examples of supporting remote unit uplink tests in a DAS employing a centralized test signal generator to generate a plurality of uplink test signals for conducting remote unit uplink tests starting at FIG. 3, an overview of an exemplary DAS for supporting conventional remote unit uplink tests is first discussed with reference to FIG. 2. The discussion of specific exemplary aspects of supporting remote unit uplink tests employing a centralized test signal generator to generate a plurality of uplink test signals for conducting remote unit uplink tests starts at FIG. 3.

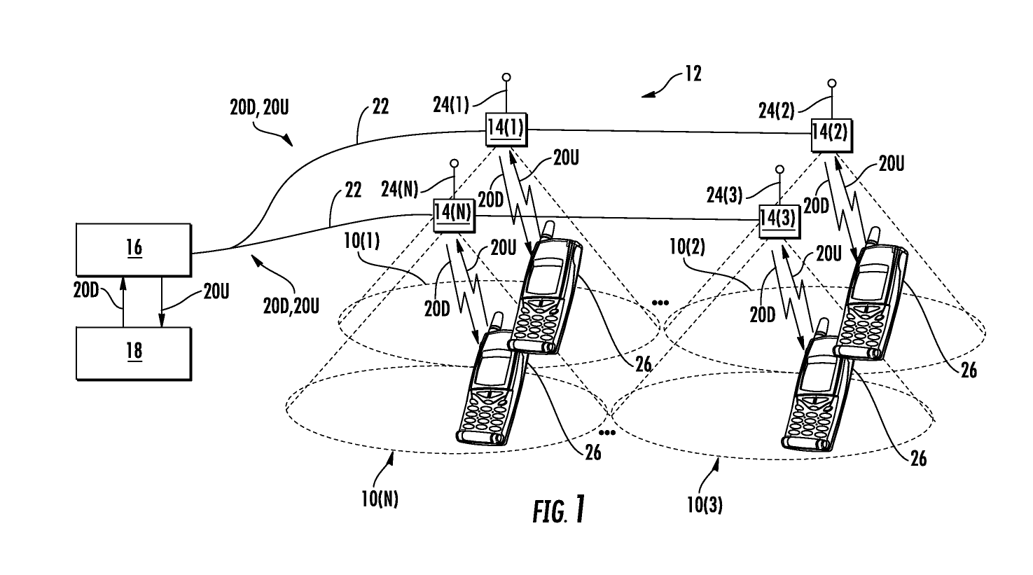

In this regard, FIG. 2 is a schematic diagram of an exemplary DAS 12(1) that supports the conventional remote unit uplink tests by using respective test signal generators 28(1)-28(N) to generate respective uplink test signals 30(1)-30(N) for the RAUs 14(1)-14(N) of FIG. 1. In a non-limiting example, the DAS 12(1) may be a digital DAS or an analog DAS. The respective test signal generators 28(1)-28(N) may be collocated with the RAUs 14(1)-14(N) as standalone equipment or provided inside a chassis of the RAUs 14(1)-14(N). The respective test signal generators 28(1)-28(N) generate the respective uplink test signals 30(1)-30(N) for the RAUs 14(1)-14(N). The respective uplink test signals 30(1)-30(N) are provided to an uplink interface 32, which may be provided in an HEE 16(1) as an example. A signal monitor 34 may be configured to receive the respective uplink test signals 30(1)-30(N) transmitted by the RAUs 14(1)-14(N), thereby the signal monitor 34 is able to analyze and evaluate uplink performance of the RAUs 14(1)-14(N). In a non-limiting example, the uplink interface 32 may include RF switches as well as an RF combiner to enable the selection and summation of multiple signals from the RAUs 14(1)-14(N). Given that the RAUs 14(1)-14(N) are each provided with the respective test signal generators 28(1)-28(N), this can increase equipment costs associated with the remote unit uplink tests. Furthermore, additional power, space, and improved heat dissipation mechanisms may be needed in each of the RAUs 14(1)-14(N) to accommodate the respective test signal generators 28(1)-28(N). Hence, it may be desirable to be able to conduct remote unit uplink tests for the RAUs 14(1)-14(N) without providing the respective test signal generators 28(1)-28(N) in each of the RAUs 14(1)-14(N).

In this regard, FIG. 3 is a schematic diagram of an exemplary DAS 40 that employs a centralized test signal generator 42 to generate a plurality of uplink test signals 44(1)-44(N) for conducting the remote unit uplink tests (hereinafter referred to as “RAU uplink tests”) at a plurality of RAUs 46(1)-46(N), respectively. By employing the centralized test signal generator 42, as opposed to providing the plurality of uplink test signals 44(1)-44(N) from one or more respective test signal generators (not shown) collocated with the plurality of RAUs 46(1)-46(N), it is possible to reduce costs and improve efficiencies of the RAU uplink tests in the DAS 40.

With reference to FIG. 3, in contrast to the DAS 12(1) of FIG. 2, wherein the RAUs 14(1)-14(N) are associated with the respective test signal generators 28(1)-28(N), the DAS 40 utilizes the centralized test signal generator 42 to perform the RAU uplink tests for the plurality of RAUs 46(1)-46(N). The centralized test signal generator 42 is located remotely from the plurality of RAUs 46(1)-46(N). In a non-limiting example, the centralized test signal generator 42 may be provided in an HEE 48, which comprises a downlink service router 50 and an uplink service router 52. The downlink service router 50 and the uplink service router 52 are respectively coupled to the plurality of RAUs 46(1)-46(N) over at least one downlink communications medium 54 and at least one uplink communications medium 56. The downlink service router 50 can route the plurality of test signals 44(1)-44(N) to any of the plurality of RAUs 46(1)-46(N) respectively over the downlink communications medium 54. In another non-limiting example, the downlink communications medium 54 and the uplink communications medium 56 may be an optical fiber-based downlink communications medium and an optical fiber-based uplink communications medium, respectively. By being located remotely from the plurality of RAUs 46(1)-46(N), the centralized test signal generator 42 is configured to distribute the plurality of uplink test signals 44(1)-44(N) to the plurality of RAUs 46(1)-46(N) over the downlink communications medium 54.

With continuing reference to FIG. 3, the centralized test signal generator 42 is communicatively coupled to the downlink service router 50. The centralized test signal generator 42 provides the plurality of uplink test signals 44(1)-44(N) to the downlink service router 50 for distribution to the plurality of RAUs 46(1)-46(N) over the downlink communications medium 54. The plurality of RAUs 46(1)-46(N) receives the plurality of uplink test signals 44(1)-44(N) over the downlink communications medium 54. Subsequently, the plurality of RAUs 46(1)-46(N) respectively returns the plurality of uplink test signals 44(1)-44(N) to the uplink service router 52 in the HEE 48 over the uplink communications medium 56. A signal monitor 58 in turn receives the plurality of uplink test signals 44(1)-44(N) from the uplink service router 52. The signal monitor 58 is configured to analyze and evaluate the plurality of uplink test signals 44(1)-44(N) returned by the plurality of RAUs 46(1)-46(N) to determine the uplink performance of the plurality of RAUs 46(1)-46(N) in the DAS 40. Hence, by utilizing the centralized test signal generator 42 to provide the plurality of uplink test signals 44(1)-44(N), as opposed to providing the plurality of uplink test signals 44(1)-44(N) from the one or more respective test signal generators collocated with the plurality of RAUs 46(1)-46(N), it is possible to perform the RAU uplink tests more efficiently with reduced equipment cost, power consumption, and installation space.

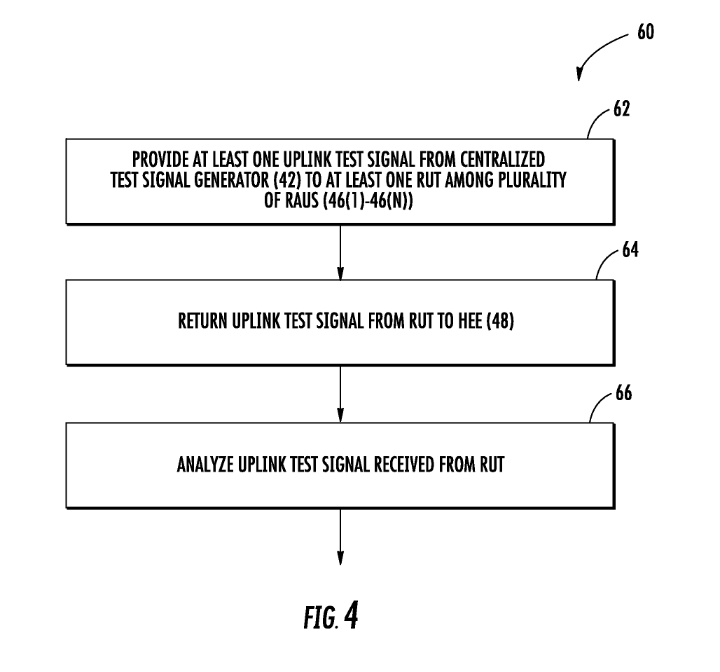

FIG. 4 is a flowchart of an exemplary uplink test process 60 for supporting the RAU uplink tests in the DAS 40 of FIG. 3 using the centralized test signal generator 42. Elements of FIG. 3 are referenced in connection to FIG. 4 and will not be re-described herein.

According to the uplink test process 60, the centralized test signal generator 42 of FIG. 3 provides at least one uplink test signal to at least one RUT among the plurality of RAUs 46(1)-46(N) (block 62). The centralized test signal generator 42 is located remotely from the plurality of RAUs 46(1)-46(N) and distributes the uplink test signal to the RUT over the downlink communications medium 54. The RUT, upon receiving the uplink test signal from the centralized test signal generator 42, returns the uplink test signal to the HEE 48 over the uplink communications medium 56 (block 64). The uplink test signal received from the RUT is then analyzed at the HEE 48 to determine the uplink performance of the RUT (block 66) to HEE 48. In a first non-limiting example, the uplink test signal may comprise test data encoded in various modulation coding schemes (MCSs), discrete tone(s), and/or frame structures associated with various types of cellular technologies to help evaluate uplink data rates and uplink bit error rates (BER) of the RUT. In a second non-limiting example, the uplink test signal may be designed to validate physical layer characteristics, such as cyclic prefix (CP), sub-channelization, and so on. In a third non-limiting example, the uplink test signal may be used to evaluate quality of service (QoS) related aspects such as uplink latency, jitter, uplink throughput, and so on. In a fourth non-limiting example, the uplink test signal received from the RUT may be analyzed by a human or an analysis system (not shown).

It shall be appreciated that the uplink test process 60 and the centralized test signal generator 42 of FIG. 3 may be employed in other indoor communication systems based on such technologies as Bluetooth and Wi-Fi. In addition, the uplink test process 60 and the centralized test signal generator 42 of FIG. 3 may also be applied in indoor systems providing location based services based on GPS signal or other location service technologies. Furthermore, the uplink test process 60 and the centralized test signal generator 42 of FIG. 3 may be applied in both analog and digital communication systems, including but not limited to time-division multiplexing (TDM) system with a common public radio interface (CPRI) and packet based systems with an Ethernet, Internet Protocol (IP) and/or passive optical network (PON) interface.

With reference back to FIG. 3, in some cases, the RAU uplink tests may be conducted on a subset of RAUs among the plurality of RAUs 46(1)-46(N). In this regard, the centralized test signal generator 42 may be configured to generate the uplink test signal, for example uplink test signal 44(X), for the RUT, for example RAU 46(X). For convenience of illustration, the RAU 46(X), which may be any of the plurality of RAUs 46(1)-46(N), is discussed hereinafter in association with the uplink test signal 44(X) as a non-limiting example of the RUT on which the RAU uplink tests are performed. As such, the RAU 46(X) is hereinafter referred to as the RUT 46(X). RAU uplink test mechanisms discussed herein are applicable to the plurality of RAUs 46(1)-46(N) as well. It should be understood that the uplink test signal 44(X) is not limited to the RUT 46(X). In a non-limiting example, the uplink test signal 44(X) can be provided to any of the plurality of RAUs 46(1)-46(N) over the downlink communications medium 54 and the uplink communications medium 56.

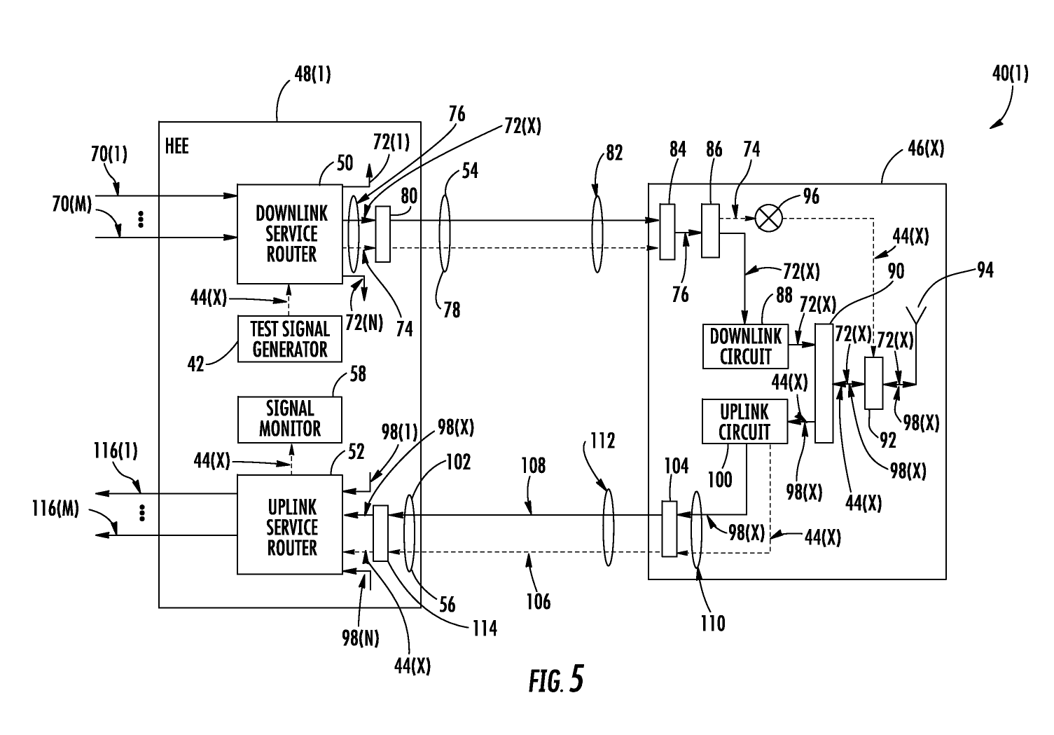

In this regard, FIG. 5 is a schematic diagram of an exemplary DAS 40(1), wherein the uplink test signal 44(X) of FIG. 3 is modulated to an intermediate frequency (IF) before being distributed to the RUT 46(X). Common elements between FIGS. 3 and 5 are shown therein with common element numbers and will not be re-described herein.

With reference to FIG. 5, an HEE 48(1) in the DAS 40(1) receives one or more downlink signals 70(1)-70(M) from one or more signal sources (not shown). In a non-limiting example, the one or more signal sources may be cellular base transceiver stations (BTSs) or baseband units (BBUs). The HEE 48(1) generates a plurality of downlink communication signals 72(1)-72(N) for distribution to the plurality of RAUs 46(1)-46(N), respectively. Among the plurality of downlink communication signals 72(1)-72(N), a respective downlink communication signal 72(X) is distributed to the RUT 46(X) among the plurality of RAUs 46(1)-46(N). The uplink test signal 44(X), which is generated by the centralized test signal generator 42, is modulated by a modulator (not shown) to generate an IF uplink test signal 74, wherein the IF is different from a frequency of the respective downlink communication signal 72(X). In case the DAS 40(1) is an analog DAS, the use of the IF uplink test signal 74 allows the centralized test signal generator 42 to send the IF uplink test signal 74 together with the respective downlink communication signal 72(X) over the downlink communications medium 54 without causing interference to the respective downlink communication signal 72(X). In a non-limiting example, the modulator may be provided in the downlink service router 50. Given that the IF uplink test signal 74 and the respective downlink communication signal 72(X) are at different frequencies, it is possible to multiplex the IF uplink test signal 74 and the respective downlink communication signal 72(X) into a multiplexed downlink signal 76.

With continuing reference to FIG. 5, in a non-limiting example, the downlink communications medium 54 in the DAS 40(1) may be at least one optical fiber-based downlink communications medium 78. In this regard, a first electrical-to-optical (E/O) converter 80 is provided in the HEE 48(1) to convert the multiplexed downlink signal 76 into a multiplexed optical downlink signal 82 before distribution to the RUT 46(X). In this regard, the multiplexed optical downlink signal 82 comprises the IF uplink test signal 74 and the respective downlink communication signal 72(X).

With continuing reference to FIG. 5, the RUT 46(X) receives the multiplexed optical downlink signal 82 over the optical fiber-based downlink communications medium 78. A first optical-to-electrical (O/E) converter 84 in the RUT 46(X) converts the multiplexed optical downlink signal 82 back to the multiplexed downlink signal 76. A de-multiplexer 86 in the RUT 46(X) de-multiplexes the multiplexed downlink signal 76 back to the IF uplink test signal 74 and the respective downlink communication signal 72(X). The respective downlink communication signal 72(X) is received and further processed by a downlink circuit 88. The respective downlink communication signal 72(X) is then provided to a coupling device 90, which couples the downlink circuit 88 to a summation point 92 for distributing the respective downlink communication signal 72(X) via a main antenna 94.

With continuing reference to FIG. 5, the IF uplink test signal 74 is demodulated back to the uplink test signal 44(X) by a demodulator 96 and provided to the summation point 92. While the RUT 46(X) is being tested by the uplink test signal 44(X), the RUT 46(X) may continue receiving a respective uplink communication signal 98(X), provided that the respective uplink communication signal 98(X) occupies a different frequency from the uplink test signal 44(X). In this regard, the RUT 46(X) is in an operating mode, wherein both the uplink test signal 44(X) and the respective uplink communication signal 98(X) are provided to an uplink circuit 100 through the coupling device 90. In a non-limiting example, it is also possible to block the respective uplink communication signal 98(X) while the RUT 46(X) is being tested by the uplink test signal 44(X). In this case, the RUT 46(X) is in a commissioning mode, wherein only the uplink test signal 44(X) is provided to the uplink circuit 100 through the coupling device 90.

With continuing reference to FIG. 5, in a non-limiting example, the uplink communications medium 56 in the DAS 40(1) may be at least one optical fiber-based uplink communications medium 102. In this regard, if the RUT 46(X) is in the commissioning mode, a second E/O converter 104 in the RUT 46(X) converts the uplink test signal 44(X) into at least one optical uplink test signal 106 for distribution to the HEE 48(1) over the optical fiber-based uplink communications medium 102. If the RUT 46(X) is in the operating mode, however, the second E/O converter 104 also converts the respective uplink communication signal 98(X) into a respective optical uplink communication signal 108 for distribution to the HEE 48(1) over the optical fiber-based uplink communications medium 102. In a non-limiting example, it is also possible to multiplex the uplink test signal 44(X) and the respective uplink communication signal 98(X) to generate a multiplexed uplink signal 110. As such, the second E/O converter 104 converts the multiplexed uplink signal 110 into a multiplexed optical uplink signal 112 for distribution to the HEE 48(1) over the optical fiber-based uplink communications medium 102.

With continuing reference to FIG. 5, a second O/E converter 114 is provided in the HEE 48(1) to convert the optical uplink test signal 106 back into the uplink test signal 44(X). If the respective optical uplink communication signal 108 is received over the optical fiber-based uplink communications medium 102, the second O/E converter 114 further converts the respective optical uplink communication signal 108 back to the respective uplink communication signal 98(X). If the multiplexed optical uplink signal 112 is received over the optical fiber-based uplink communications medium 102, the second O/E converter 114 then converts the multiplexed optical uplink signal 112 back to the uplink test signal 44(X) and the respective uplink communication signal 98(X). The uplink test signal 44(X) and the respective uplink communication signal 98(X) are subsequently received by the uplink service router 52.

With continuing reference to FIG. 5, the uplink service router 52 may receive a plurality of respective uplink communication signals 98(1)-98(N), which includes the respective uplink communication signal 98(X), from the plurality of RAUs 46(1)-46(N) (not shown). The HEE 48(1) is configured to generate one or more uplink signals 116(1)-116(M) for distribution to the one or more signal sources, respectively. The uplink test signal 44(X) is provided to the signal monitor 58 by the uplink service router 52 to be analyzed and evaluated.

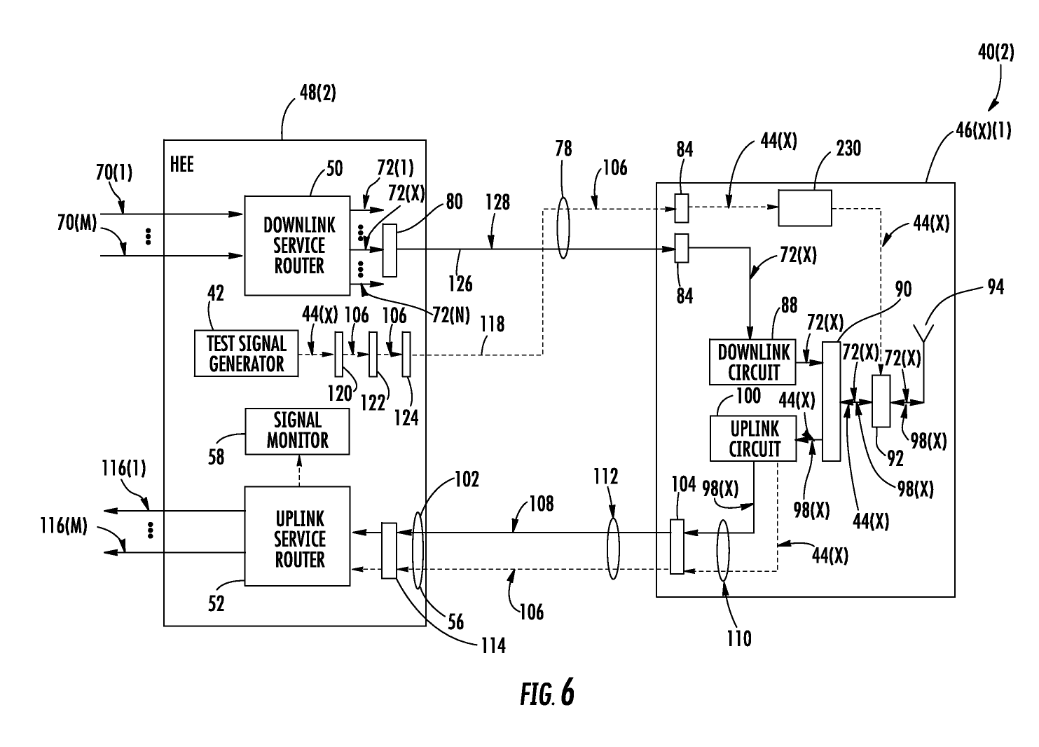

With continuing reference to FIG. 5, the optical fiber-based downlink communications medium 78 that communicatively couples the HEE 48(1) to the RUT 46(X) may contain unused optical fibers (also known as dark fibers). In this case, it may be possible to distribute the uplink test signal 44(X) directly to the RUT 46(X) via the unused optical fibers, as opposed to multiplexing the uplink test signal 44(X) with the respective downlink communication signal 72(X). In this regard, FIG. 6 is a schematic diagram of an exemplary DAS 40(2), wherein the uplink test signal 44(X) of FIG. 5 is distributed from an HEE 48(2) to an RUT 46(X)(1) over at least one downlink test signal optical fiber 118 comprised in the optical fiber-based downlink communications medium 78. Common elements between FIGS. 5 and 6 are shown therein with common element numbers and will not be re-described herein.

With reference to FIG. 6, the HEE 48(2) comprises a test signal E/O converter 120, an optical amplifier 122, and an optical splitter 124. The optical splitter 124 is coupled to the downlink test signal optical fiber 118. The test signal E/O converter 120 converts the uplink test signal 44(X) to the optical uplink test signal 106 for distribution to the RUT 46(X)(1) over the downlink test signal optical fiber 118. The downlink test signal optical fiber 118 may also comprise at least one downlink communication signal optical fiber 126. The first E/O converter 80 in the HEE 48(2) converts the respective downlink communication signal 72(X) into a respective optical downlink communication signal 128 for distribution to the RUT 46(X)(1) over the downlink communication signal optical fiber 126. In a non-limiting example, the downlink test signal optical fiber 118 may be configured to be a shared medium for distributing the plurality of uplink test signals 44(1)-44(N) to the plurality of RAUs 46(1)-46(N). In this regard, each of the plurality of uplink test signals 44(1)-44(N) shall be first converted to respective IF uplink test signals, such as the IF uplink test signal 74 of FIG. 5, before being transmitted over the downlink test signal optical fiber 118.

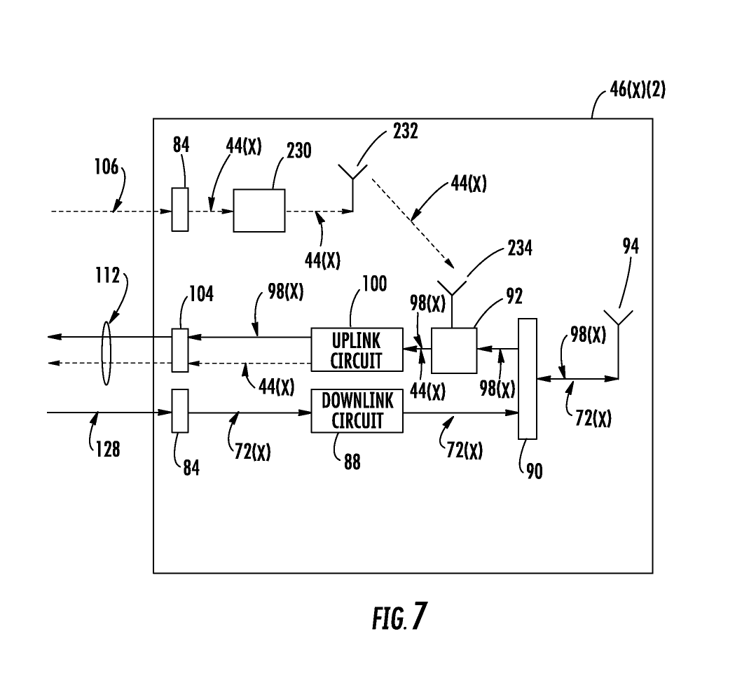

With continuing reference to FIG. 6, the first O/E converter 84 in the RUT 46(X)(1) is coupled to the downlink test signal optical fiber 118 and the downlink communication signal optical fiber 126. The first O/E converter 84 converts the optical uplink test signal 106 and the respective optical downlink communication signal 128 back to the uplink test signal 44(X) and the respective downlink communication signal 72(X), respectively. The respective downlink communication signal 72(X) is provided to the downlink circuit 88 to be communicated via the main antenna 94. The uplink test signal 44(X) is received by a circuit 230 and then provided to the summation point 92. In contrast to the DAS 40(1) of FIG. 5, the uplink test signal 44(X) does not need to be modulated to the IF uplink test signal 74 at the HEE 48(2) and demodulated back to the uplink test signal 44(X) at the RUT 46(X)(1). As an alternative to providing the uplink test signal 44(X) to the uplink circuit 100 via the summation point 92, it is also possible to provide the uplink test signal 44(X) to the uplink circuit 100 wirelessly. In this regard, FIG. 7 is a schematic diagram of an exemplary RUT 46(X)(2), wherein the uplink test signal 44(X) of FIG. 6 is wirelessly communicated to the uplink circuit 100 before being communicated to the HEE 48(2) (not shown). Common elements between FIGS. 6 and 7 are shown therein with common element numbers and will not be re-described herein. With reference to FIG. 7, the RUT 46(X)(2) comprises a first antenna 232, which is coupled to the circuit 230, and a second antenna 234 that is coupled to the summation point 92. The uplink test signal 44(X) is communicated from the first antenna 232 to the second antenna 234 wirelessly. As a result, it is possible to reduce processing delay associated with the summation point 92 and the coupling device 90.

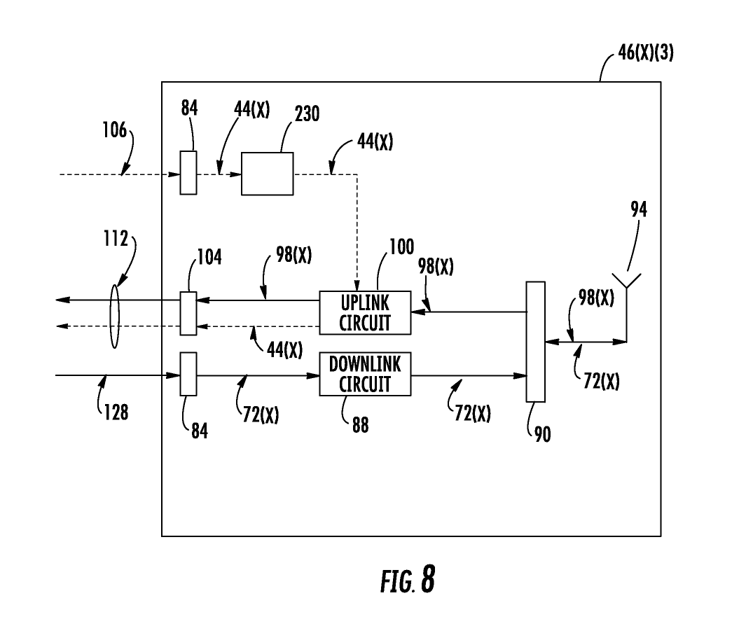

FIG. 8 is a schematic diagram of an exemplary RUT 46(X)(3), wherein the uplink test signal 44(X) of FIG. 6 is directly provided to the uplink circuit 100 before being communicated to the HEE 48(2) (FIG. 6). Common elements between FIGS. 6 and 8 are shown therein with common element numbers and will not be re-described herein.

As illustrated in FIG. 8, the uplink test signal 44(X) is directly provided to the uplink circuit 100 before being communicated to the HEE 48(2). As such, the uplink circuit 100 is also functioning as the summation point 92 (not shown) of FIG. 6. By eliminating the summation point 92, it is possible to reduce cost and processing latency associated with the summation point 92.

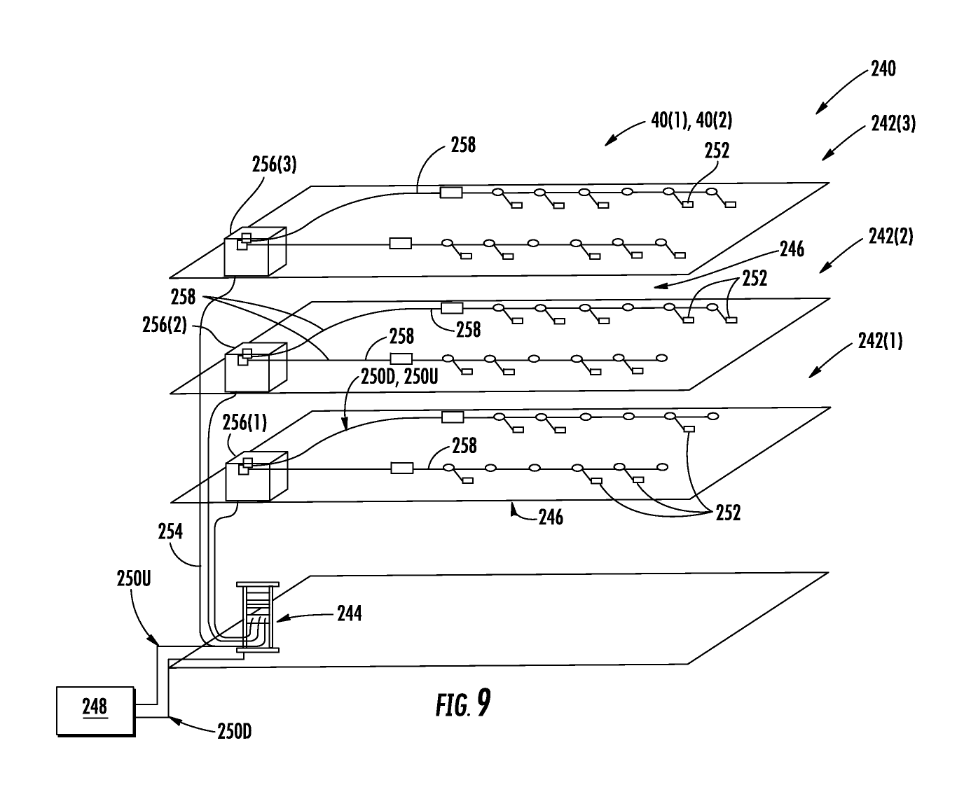

The DAS 40(1) of FIG. 5 and the DAS 40(2) of FIG. 6, which are configured to support the RAU uplink tests based on the centralized test signal generator 42, may be provided in an indoor environment, as illustrated in FIG. 9. FIG. 9 is a partial schematic cut-away diagram of an exemplary building infrastructure 240 in which the DAS 40(1) of FIG. 5 and the DAS 40(2) of FIG. 6 can be employed. The building infrastructure 240 in this embodiment includes a first (ground) floor 242(1), a second floor 242(2), and a third floor 242(3). The floors 242(1)-242(3) are serviced by a central unit 244 to provide antenna coverage areas 246 in the building infrastructure 240. In this regard, in a non-limiting example, the centralized test signal generator 42 may be provided in the central unit 244. The central unit 244 is communicatively coupled to a base station 248 to receive downlink communications signals 250D from the base station 248. The central unit 244 is communicatively coupled to a plurality of RAUs 252 to distribute the downlink communications signals 250D to the plurality of RAUs 252 and to receive uplink communications signals 250U from the plurality of RAUs 252, as previously discussed above. The downlink communications signals 250D and the uplink communications signals 250U communicated between the central unit 244 and the plurality of RAUs 252 are carried over a riser cable 254. The riser cable 254 may be routed through interconnect units (ICUs) 256(1)-256(3) dedicated to each of the floors 242(1)-242(3) that route the downlink communications signals 250D and the uplink communications signals 250U to the plurality of RAUs 252 and also provide power to the plurality of RAUs 252 via array cables 258.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that any particular order be inferred.

It will be apparent to those skilled in the art that various modifications and variations can be made without departing from the spirit or scope of the invention. Since modifications, combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. A distributed antenna system (DAS) configured to support remote unit uplink tests, comprising:
a head-end equipment (HEE) communicatively coupled to a plurality of RAUs over at least one downlink communications medium and at least one uplink communications medium, the HEE comprising a signal monitor; and
a centralized test signal generator located remotely from the plurality of RAUs, the centralized test signal generator configured to generate at least one uplink test signal and distribute the at least one uplink test signal to at least one RAU under test (RUT) among the plurality of RAUs over the at least one downlink communications medium;
wherein:
the at least one RUT is configured to return the at least one uplink test signal to the HEE over the at least one uplink communications medium; and
the signal monitor is configured to analyze the at least one uplink test signal received from the at least one RUT to determine uplink performance of the at least one RUT.

2. The DAS of claim 1, wherein the centralized test signal generator is provided in the HEE.

3. The DAS of claim 1, wherein the HEE is further configured to:
generate a plurality of downlink communication signals based on one or more downlink signals received from one or more signal sources;
provide the plurality of downlink communication signals to the plurality of RAUs, respectively, over the at least one downlink communications medium;
generate one or more uplink signals based on a plurality of uplink communication signals received from the plurality of RAUs, respectively, over the at least one uplink communications medium; and
provide the one or more uplink signals to the one or more signal sources.

4. The DAS of claim 3, wherein the HEE comprises a downlink signal router configured to modulate at least one uplink test signal to an intermediate frequency (IF) uplink test signal and multiplex the IF uplink test signal with a respective downlink communication signal to be distributed to the at least one RUT among the plurality of downlink communication signals.

5. The DAS of claim 4, wherein the at least one RUT comprises:
a de-multiplexer configured to de-multiplex the IF uplink test signal and the respective downlink communication signal;
a demodulator configured to demodulate the IF uplink test signal to the at least one uplink test signal; and
a summation point configured to provide the at least one uplink test signal to an uplink circuit, the uplink circuit configured to return the at least one uplink test signal to the HEE over the at least one uplink communications medium.

6. The DAS of claim 5, wherein the uplink circuit is configured to multiplex the at least one uplink test signal with a respective uplink communication signal to be provided to the HEE by the at least one RUT.

7. The DAS of claim 3, wherein:
the at least one downlink communications medium is comprised of at least one optical fiber-based downlink communications medium, comprising:
at least one downlink communication signal optical fiber configured to distribute the plurality of downlink communication signals to the plurality of RAUs; and
at least one downlink test signal optical fiber configured to provide at least one uplink test signal to the at least one RUT among the plurality of RAUs; and
the at least one uplink communications medium is comprised of at least one optical fiber-based uplink communications medium.

8. The DAS of claim 7, wherein a first electrical-to-optical (E/O) converter is configured to convert the at least one uplink test signal to at least one optical uplink test signal before being provided to the at least one RUT over the at least one downlink test signal optical fiber.

9. The DAS of claim 8, wherein the at least one RUT comprises:
a first optical-to-electrical (O/E) converter configured to convert the at least one optical uplink test signal to the at least one uplink test signal;
a summation point configured to provide the at least one uplink test signal to an uplink circuit, the uplink circuit configured to return the at least one uplink test signal to the HEE; and
a second E/O converter configured to convert the at least one uplink test signal to the at least one optical uplink test signal for distribution to the HEE over the at least one optical fiber-based uplink communications medium.

10. The DAS of claim 9, wherein the HEE further comprises a second O/E converter coupled to the at least one optical fiber-based uplink communications medium, the second O/E converter configured to convert the at least one optical uplink test signal back to the at least one uplink test signal and provide the at least one uplink test signal to the signal monitor for analysis.

11. The DAS of claim 8, wherein the at least one RUT comprises:
a first optical-to-electrical (O/E) converter configured to convert the at least one optical uplink test signal to the at least one uplink test signal;
a circuit configured to distribute the at least one uplink test signal wirelessly via a first antenna coupled to the circuit;
a summation point coupled to a second antenna, the summation point configured to:
receive the at least one uplink test signal via the second antenna; and
provide the at least one uplink test signal to an uplink circuit configured to return the at least one uplink test signal to the HEE; and
a second E/O converter configured to convert the at least one uplink test signal to the at least one optical uplink test signal for distribution to the HEE over the at least one optical fiber-based uplink communications medium.

12. The DAS of claim 8, wherein the at least one RUT comprises:
a first optical-to-electrical (O/E) converter configured to convert the at least one optical uplink test signal to the at least one uplink test signal;
a circuit configured to provide the at least one uplink test signal to an uplink circuit configured to return the at least one uplink test signal to the HEE; and
a second E/O converter configured to convert the at least one uplink test signal to the at least one optical uplink test signal for distribution to the HEE over the at least one optical fiber-based uplink communications medium.

13. A method for performing remote unit uplink tests in a distributed antenna system (DAS), comprising:
providing at least one uplink test signal from a centralized test signal generator to at least one remote antenna unit (RAU) under test (RUT) among a plurality of RAUs in a DAS, wherein the centralized test signal generator is located remotely from the plurality of RAUs;
returning the at least one uplink test signal from the at least one RUT to a head-end equipment (HEE) in the DAS; and
analyzing the at least one uplink test signal received from the at least one RUT to determine uplink performance of the at least one RUT.

14. The method of claim 13, further comprising:
converting the at least one uplink test signal to an intermediate frequency (IF) uplink test signal; and
multiplexing the at least one uplink test signal with a respective downlink communication signal provided by the HEE to the at least one RUT.

15. The method of claim 14, further comprising multiplexing the at least one uplink test signal with a respective uplink communication signal to be provided to the HEE by the at least one RUT.

16. The method of claim 13, further comprising:
converting the at least one uplink test signal into at least one optical uplink test signal; and
providing the at least one optical uplink test signal to the at least one RUT over at least one downlink test signal optical fiber configured to provide the at least one optical uplink test signal to the at least one RUT among the plurality of RAUs.

17. The method of claim 16, further comprising providing the at least one optical uplink test signal to the HEE over at least one optical fiber-based uplink communications medium.

18. A head-end equipment (HEE) in a distributed antenna system (DAS) configured to support remote unit uplink tests, comprising:
a downlink service router communicatively coupled to a plurality of remote antenna units (RAUs) over at least one downlink communications medium, the downlink service router configured to:
generate a plurality of downlink communication signals based on one or more downlink signals received from one or more signal sources; and
provide the plurality of downlink communication signals to the plurality of RAUs, respectively, over the at least one downlink communications medium;
an uplink service router communicatively coupled to the plurality of RAUs over at least one uplink communications medium, the uplink service router configured to:
generate one or more uplink signals based on a plurality of uplink communication signals received from the plurality of RAUs, respectively, over the at least one uplink communications medium; and
provide the one or more uplink signals to the one or more signal sources;
a test signal generator configured to:
generate at least one uplink test signal to at least one RAU under test (RUT) among the plurality of RAUs; and
provide the at least one uplink test signal to at least one RUT through the downlink service router; and
a signal monitor configured to analyze the at least one uplink test signal returned by the at least one RUT and received through the uplink service router.

19. The HEE of claim 18, wherein:
the downlink service router communicatively coupled to the plurality of RAUs over at least one optical fiber-based downlink communications medium, the downlink service router configured to:
generate the plurality of downlink communication signals based on the one or more downlink signals received from the one or more signal sources; and
provide the plurality of downlink communication signals to the plurality of RAUs, respectively, over the at least one optical fiber-based downlink communications medium; and
the uplink service router communicatively coupled to the plurality of RAUs over at least one optical fiber-based uplink communications medium, the uplink service router configured to:
generate the one or more uplink signals based on the plurality of uplink communication signals received from the plurality of RAUs, respectively, over the at least one optical fiber-based uplink communications medium; and
provide the one or more uplink signals to the one or more signal sources.

20. The HEE of claim 19, further comprising:
a test signal electrical-to-optical (E/O) converter coupled to the test signal generator, the test signal E/O converter configured to convert the at least one uplink test signal into at least one optical uplink test signal;
an optical amplifier coupled to the test signal E/O converter, the optical amplifier configured to amplify the at least one optical uplink test signal; and
an optical splitter coupled to the optical amplifier, the optical splitter configured to provide the at least one optical uplink test signal to the at least one RUT over at least one downlink test signal optical fiber dedicated to distribute the at least one uplink test signal to the at least one RUT.
